(19) United States
(12) Patent Application Publication
(10) Pub. No.: US 2012/0175065 A1
(43) Pub. Date: Jul. 12, 2012

(54) PRIVACY DEVICE FOR A STALL

(76) Inventor: Dan Mayzum, Neenah, WI (US)

(21) Appl. No.: 13/349,488

(22) Filed: Jan. 12, 2012

Related U.S. Application Data
(60) Provisional application No. 61/431,964, filed on Jan. 12, 2011.

(51) Int. Cl. E06B 5/02

(52) U.S. Cl. 160/24; 160/405

(57) ABSTRACT

One aspect of the invention is directed to a portable privacy device for a stall. The device includes a privacy tape coiled in a housing. The privacy tape is of a size sufficient to bridge at least a portion of a space between a stall door and an adjacent partition panel and is retractable along its length into the housing through an access opening in the housing. The housing has a channel configured to engage at least one of the door or the partition. The channel is defined by first and second surfaces for contacting the upper or lower ends of at least one of a door or a partition. In some embodiments, the channel includes a third surface adjacent the first surface and opposite the second the surface. Aspects of the invention are also directed to methods of improving privacy in a stall.

### RELATED APPLICATION

This application claims the benefit of and priority to Provisional Application Ser. No. 61/431,964 filed Jan. 12, 2012, the disclosure of which is expressly incorporated herein by reference in its entirety.

### FIELD OF THE INVENTION

This invention relates generally to privacy devices for a stall and particularly to portable privacy devices for a stall.

### BACKGROUND OF THE INVENTION

Privacy in public stalls such as in restrooms, showers, locker rooms, changing rooms, fitting rooms, and other such places, is not easily obtained. Public stalls are typically formed by an arrangement of partition panels and a door that swings between an opened position and a closed position. A space exists between adjacent partition panels as well as between the partition panels and the door. Often times, this space is quite large, allowing a person outside of the stall to invade the privacy of the stall's occupant such as by peering through the space. This problem can be particularly distressing for parents with small children who are using such a stall.

Another issue that presents itself in public stalls is that often times the latch on the stall door is inoperative or the space between the stall door and the stall partition is so great that the latch is ineffective. In both instances, the door may be allowed to swing open while the stall is occupied. In addition to the privacy concerns caused by the door swinging open due, this situation also presents a security concern to the stall's occupants in that anyone can, with little or no effort, open the stall door and enter the stall.

### SUMMARY OF THE INVENTION

While the invention will be described in connection with certain embodiments, it will be understood that the invention is not limited to these embodiments. On the contrary, the invention includes all alternatives, modifications and equivalents as may be included within the spirit and scope of the present invention.

Aspects of the invention are directed to a portable privacy device for a stall. The device includes a privacy tape coiled in a housing. The privacy tape has a length and a width that are sufficient to bridge at least a portion of a space between a stall door and an adjacent partition panel. The privacy tape is retractable along its length into the housing through an access opening in the housing. The housing has a channel configured to engage at least one of the door or the partition. The channel is defined by a first surface for contacting one of an upper end surface or a lower end surface of the at least one of the door or the partition. The channel is further defined by a second surface adjacent the first surface for contacting one of a front surface or a back surface of the at least one of the door or the partition. In some embodiments, the channel include a third surface adjacent the first surface and opposite the second the surface.

In some aspects, the tape includes a pull tab couple to one end. The pull tab also has a channel configured to engage at least one of the door or the partition. The channel is defined by a first surface for contacting one of an upper end surface or a lower end surface of the at least one of the door or the partition. The channel is further defined by a second surface adjacent the first surface for contacting one of a front surface or a back surface of the at least one of the door or the partition. In some embodiments, the channel include a third surface adjacent the first surface and opposite the second the surface. The other end of the pull tab is coupled to a retraction device that functions to recoil the privacy tape back into the housing.

Some aspects of the invention are directed to a method of improving the privacy in a stall by blocking the line of sight through a space between a stall door and an adjacent partition panel. The method uses a portable privacy device having a privacy tape. The method includes selectively and removably securing a first end of the privacy tape to at least one of the door or the partition panel. The method further includes selectively and removably securing a second portion of the privacy tape to a second portion of the at least one of the door or the partition panel. The privacy tape is positioned to extend between at least a portion of the space between the door and the adjacent partition panel.

### BRIEF DESCRIPTION OF THE DRAWINGS

The accompanying drawings, which are incorporated in and constitute a part of this specification, illustrate embodiments of the invention and, together with a general description of the invention given above, and the detailed description given below, serve to explain the principles of the invention.

FIG. 1 is a perspective view of a typical stall and a portable privacy device in accordance with aspects of the invention.

FIG. 2 is a perspective view of a portable privacy device in accordance with aspects of the invention.

FIG. 3 is a cut away view of a portable privacy device in accordance with aspects of the invention.

FIG. 4A is a perspective view of an embodiment of a non-portable privacy device in accordance with aspects of the invention.

FIG. 4B is a perspective view of an alternative embodiment of a non-portable privacy device in accordance with aspects of the invention.

FIG. 4C is a perspective view of an alternative embodiment of a non-portable privacy device in accordance with aspects of the invention.

FIG. 5 is a top view of a typical stall with an embodiment of a non-portable privacy device in accordance with aspects of the invention.

FIG. 6A is a perspective view of an alternative embodiment of a non-portable privacy device with a latching mechanism in accordance with aspects of the invention.

FIG. 6B is a perspective view of an alternative embodiment of a non-portable privacy device with a space for a latching mechanism in accordance with aspects of the invention.

FIG. 7 is a perspective view of an alternative embodiment of a non-portable privacy device in accordance with aspects of the invention.

### DETAILED DESCRIPTION OF THE INVENTION

Embodiments of the inventions improve the privacy for the occupant of a stall, such as in restrooms, showers, locker rooms, changing rooms, fitting rooms, and other such places wherein privacy is desired, by blocking the line of sight through a space between a stall door and an adjacent partition panel or between adjacent panels. Embodiments of the invention may also assist in maintaining a stall door in the closed position during use, thereby keeping the stall door from swinging open as can occur in instances where the locking mechanism is broken or the space between the door and the adjacent partition panel is too large thereby rendering useless the locking mechanism associated with the door.

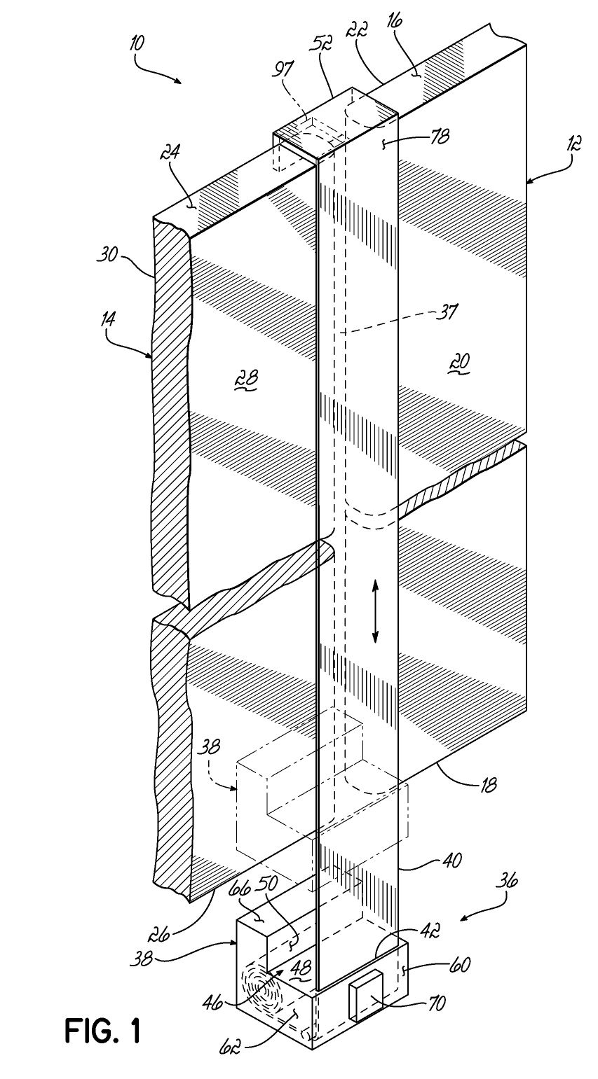

FIG. 1 shows a typical stall 10 construction having a door 12 and an adjacent partition panel 14. The door 12 has an upper end surface 16, a lower end surface 18, a front surface 20, and a back surface 22. The partition panel 14 similarly has an upper end surface 24, a lower end surface 26, a front surface 28, and a back surface 30. A space 37 is defined by the distance between the door 12 and the partition panel 14. Also shown in FIG. 1 is an exemplary embodiment of a portable privacy device 36 in accordance with embodiments of the invention. The portable privacy device 36 includes a housing 38 with a privacy tape 40 extending therefrom through an access opening 42.

The housing 38 includes a channel 46 configured to engage the door 12, the partition 14, or the combination of the door and the partition such that the privacy tape covers the space 37. The channel 46 has a first surface 48 for contacting either the upper end surface 16, 24 or the lower end surface 18, 26 of the door 12, the partition 14, or the combination of the door and the partition. The channel 46 has a second surface 50 adjacent the first surface 48 for contacting one of the front surface 20, 28 or the back surface 22, 30 of the door 12, the partition 14, or the combination of the door and the partition. In one embodiment, when the privacy tape 40 is in the uncoiled position, a portion of the privacy tape 40 adjacent the access opening 42 contacts the other of the front surface 20, 28 or the back surface 22, 30 of the door 12, the partition 14, or the combination of the door and the partition. The portion of the privacy tape adjacent the first surface is spaced apart from the second surface of the channel by a distance sufficient to allow the housing to engage the upper or lower end surfaces of at least one of a door 12 or a partition panel 14. In one embodiment, the distance between the second surface and the portion of the privacy tape adjacent the first surface is in a range between about 0.5 inches and about 1.5 inches.

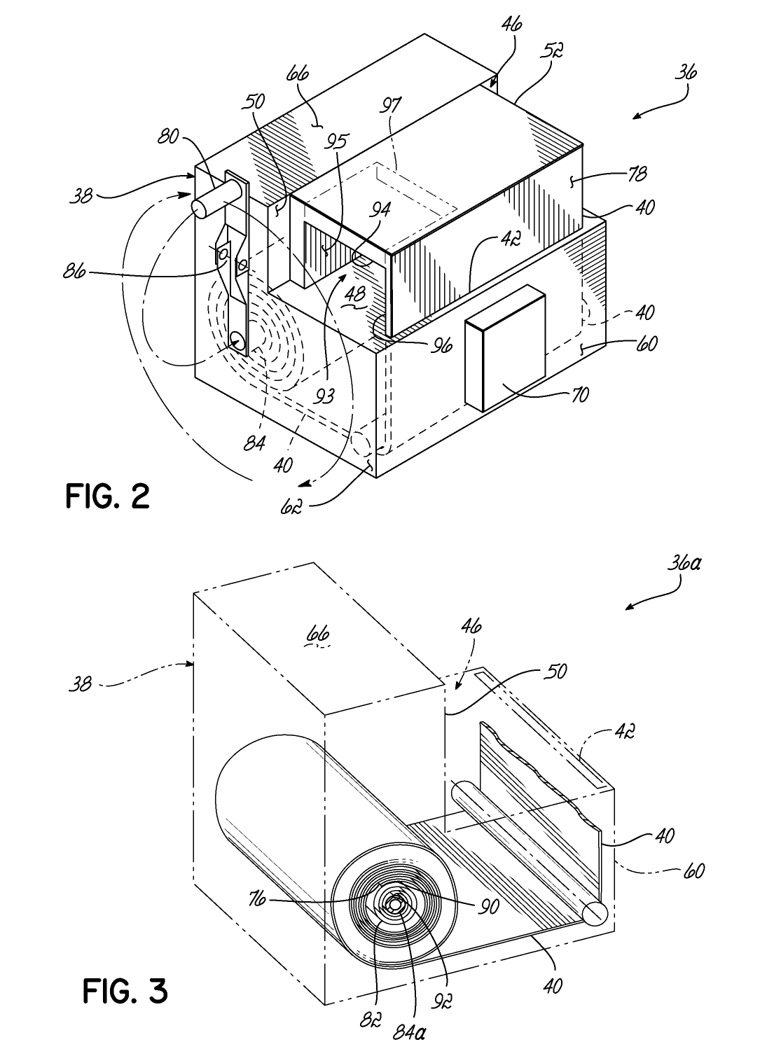

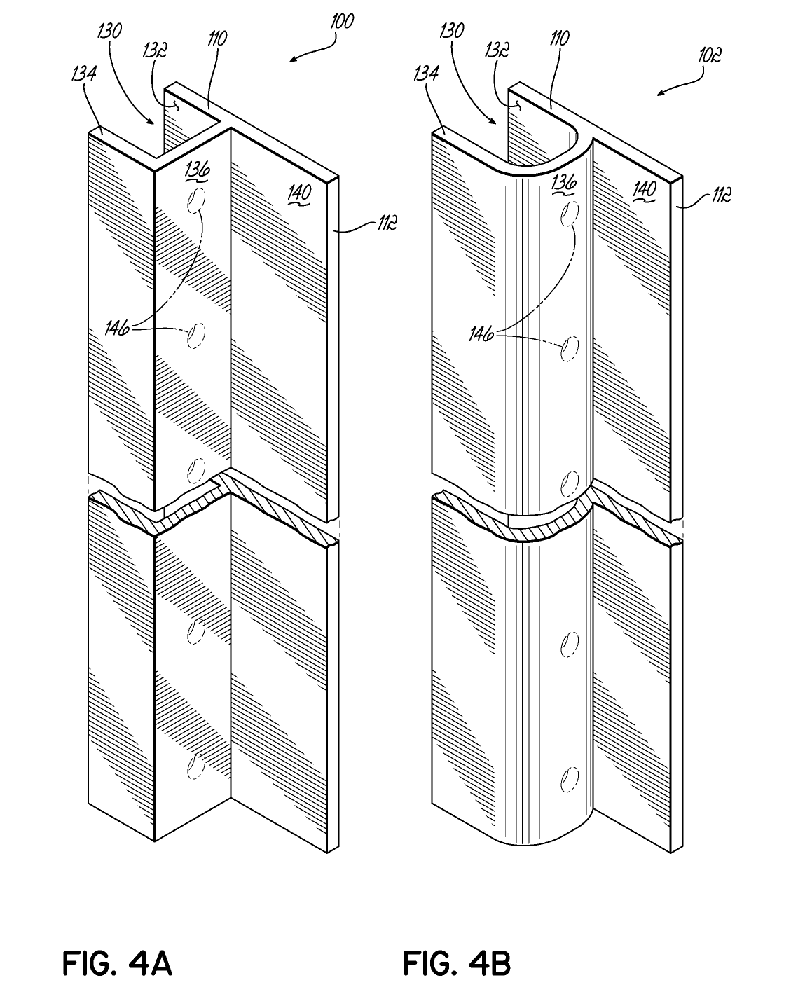

The channel 46 may be convertible from a closed configuration (FIG. 2) to an open configuration wherein the channel 46 is capable of engaging the door 12, the partition panel 14, and the combination thereof. As shown in FIGS. 1 and 2, the channel 46 is convertible between the open and closed configurations by movement of a pull tab so located at an end 52 of the privacy tape 40. When the privacy tape 40 is in the fully coiled position, the pull tab 52 blocks the channel 46 and the channel 46 is considered to be in a closed configuration (FIG. 2). When a portion of the privacy tape 40 is partially uncoiled, the channel 46 may be accessed and is considered to be in an open configuration (FIGS. 1 and 3). In some embodiments the channel may be convertible between the opened and closed configurations by movement of one or more surfaces associated with the housing to form the channel.

The length, width, and depth of the channel 46 are sufficient to allow the housing 38 to be selectively and removably secured to a first portion of the door 12, the partition panel 14 or the combination of the door and the partition panel. In the embodiment shown in FIG. 1, the channel 46 is dimensioned so that it may engage an end surface 16, 18, 24, 26 and one of the front 20, 28 or back 22, 30 surfaces of the door 12, the partition panel 14, and the combination thereof. The width of the housing 38 may be sufficient to engage both the door 12 and the partition panel 14 across the space 37. Thus, the housing 36, in conjunction with the privacy tape 40, may function as a security device to hold the door 12 in a closed position even if a locking mechanism on the door is non-functional. The length forming the channel 46 is defined by the distance from the front surface 60 of the housing 38 to the second surface 50 of the channel 46. The width is defined by the distance between a first side surface 62 of the housing 38 and a second side surface 64 of the housing 36. The depth is defined by distance from the top surface 66 of the housing 38 to the first surface 48 of the channel 46.

The portable privacy 36 device may optionally include a locking element for selectively locking the privacy tape 40 in coiled or uncoiled conformation. The optional locking element may be in the form of a button 70 coupled to a friction lock capable of reversibly engaging the privacy tape to prevent the privacy tape from being coiled or uncoiled. Those skilled in the art will appreciate that other structures may be employed for the locking element.

The privacy tape 40 extends from the housing 36 through the access opening 42. The privacy tape 40 has a first end 76 coupled to a retraction device and a second end 78 coupled to a pull tab 52. In the exemplary embodiment of FIGS. 2 and 3, the retraction device may include a crank 80 and a coil spring 82, but combinations thereof and other retraction devices may be used as well. The privacy tape 40 may be coupled to a crank 80 by a spool 84. The crank 80 may be convertible between a deployed position and a storage position such as by pivoting about one or more hinges 86. As shown in FIG. 3, the privacy tape 40 may be coupled directly to an end 90 of a coil spring 82 while the other end 92 of the coil spring 82 is anchored either directly or indirectly to the housing 36a such as by an integral spindle 82a thereby allowing the generation of a biasing force for retracting the privacy tape 40 into the housing 36a. In another embodiment, the privacy tape 40 can only be coupled to a spool that is coupled to a coil spring. Thus, in some embodiments, the privacy tape is coupled to a spool or other intermediary structure that is coupled to the retraction device. Those of ordinary skill in the art will appreciate that other types of retraction devices may be used in accordance with embodiments of the invention.

With reference to FIGS. 1 and 2, the pull tab is configured to fit over and engage the upper end surface 16, 24 or lower end surface 18, 26 of at least one of the door 12 or the partition panel 14. In one embodiment, the pull tab 52 includes a channel 93 having a first surface 94 for contacting one of an upper end surface 16, 24 or a lower end surface 28, 30 of the at least one of the door 12 or the partition panel 14. The channel 93 also includes a second surface 95 adjacent the first surface 94 for contacting the front surface 20, 28 or the back surface 22, 30 adjacent the upper 16, 24 or lower 18, 26 end surfaces. The tab may have a third surface 96 associated with the channel 93 opposite the second surface 95 and adjacent the first surface 94. The third surface 96 may optionally be formed by a portion of the privacy tape 40 adjacent the pull tab 52. The third surface 96 is spaced apart from the second surface 95 by a distance sufficient to allow the pull tab 52 to engage the upper 16, 24 or lower 18, 26 end surfaces of at least one of a door 12 or a partition 14. In one embodiment, the distance between the second surface 95 and the third surface 96 is in a range between about 0.5 inches and about 1.5 inches.

The pull tab 52 may be used to extend the privacy tape 40 from the housing 36 using a finger and/or thumb, and placing the tab 52 over the top or bottom of the stall door 12 or partition in a position relative to the space 37 between the door 12 and the panel 14 to allow the width of the tab and privacy tape 40 to bridge the space 37 between door 12 and partition panel 14 (FIG. 1). The tab 52 is configured to allow for selective and removable attachment of the device 36 to at least one of the door 12 or partition panel 14. The pull tab 52 may be an extension of the privacy tape 40 or may be a distinct structure coupled to the privacy tape at or near the end of the tape 40.

With reference to FIG. 1, an added feature of the portable device 36 is that some embodiments provide a temporary means of holding a door in a closed position such as in situations where the door lock is broken or the door and partition panel are separated away from each other such that the door cannot remain in a closed position. In some stall constructions, the partition adjacent the door extends above and or below the upper or lower ends of the door. Thus, in an embodiment, the pull tab 52 has a notch 97 formed in the structure forming the first surface 94 of the channel 93 allowing the pull tab 52 to fit around the extended partition member and to allow the second surface 95 and the third surface 96 of the channel 93 of the tab 36 to engage the front and back surfaces of the partition while the portion of the partition that extends above the upper surface or below the lower surface of the door passes through the notch 97.

In one embodiment, the privacy tape 40 has a length sufficient to allow a privacy tape 40 to extend from an upper end surface 16, 20 of the door 12, the partition panel 14 and combinations thereof, to the lower end surface 18, 22 of the door 12, the partition panel 14, and combinations thereof. The partition tape 40 generally has a length ranging between about 3 feet to about 8 feet. The privacy tape 40 has a width sufficient to allow the privacy tape to bridge the space 37 between the door 12 and a partition panel 14. In one embodiment, the privacy tape has a width in the range between about 1 inch to about 5 inches. In an alternative embodiment, the privacy tape has a width in the range between about 1 inch to about 3 inches. In an alternative embodiment, the privacy tape has a width of about 3 inches.

While the portable device is shown with a retractable device in these figures, other embodiments are contemplated. For example, portable embodiments could include a privacy tape that is coupled to other structures capable of selectively and reversibly securing the privacy tape to one or more portions of a door, a partition panel, and combinations thereof. For example, other structures such as magnets, suction cups, and hooks could be used to secure the privacy tape.

The housing can be constructed of any material with suitable structural characteristics, such as metals, plastics, and other materials, using standard manufacturing techniques. The privacy tape can be made of flexible materials including strips of fabric, plastic, rubber, paper, flexible metals, and combinations thereof. The privacy tape could include a magnetic material for use on iron based stalls. In one embodiment, the portable privacy device is of a size to easily fit and be stored conveniently in a bag or pocket.

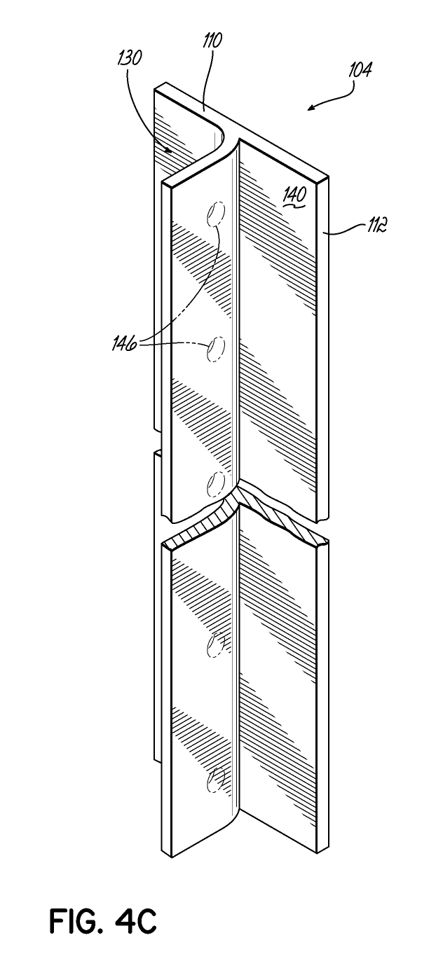

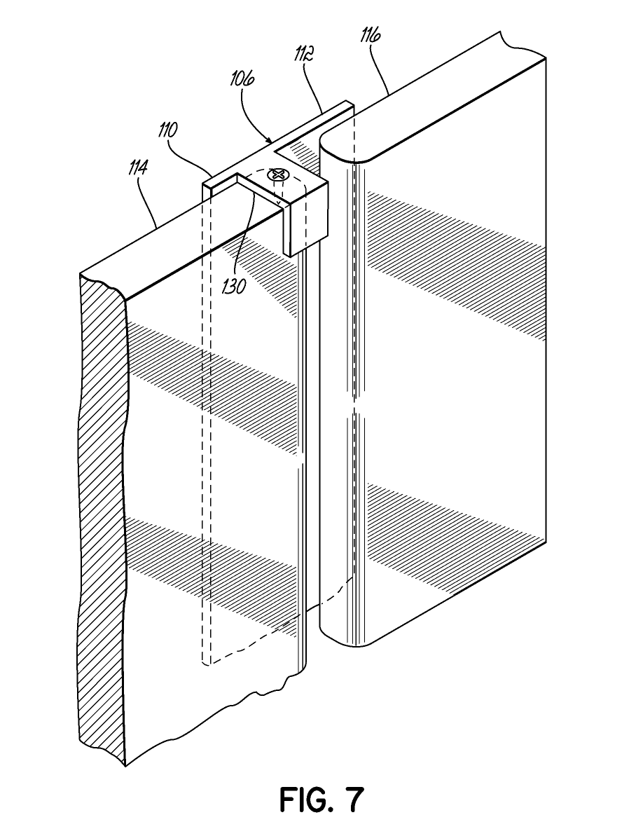

Some embodiments of the privacy device 100, 102, 104, 106 are directed to structures that may be more permanently affixed to a stall door, or partition panel, such as shown in FIGS. 4A-7. In these embodiments, the privacy devices 100, 102, 104, 106 have an elongated structure having an attachment edge 110 and an arm 112. The attachment edge 110 is configured to attach to a door 114 or partition panel 116, 118 and the arm 112 is configured to span a space 122, 124 located between a door 114 and a partition panel 116, 118, or between two partition panels. In one embodiment, the attachment edge 110 is formed by an elongated channel 130 configured to receive a side edge of a door 114 or partition panel 116, 118. The channel 130 is defined by a first wall 132 connected to a second 134 wall by third wall 136. In an alternative embodiment, the channel 130 is located at an end of the elongated structure and is configured to wrap around an upper and/or lower edge of a door 114 or partition panel (FIG. 7).

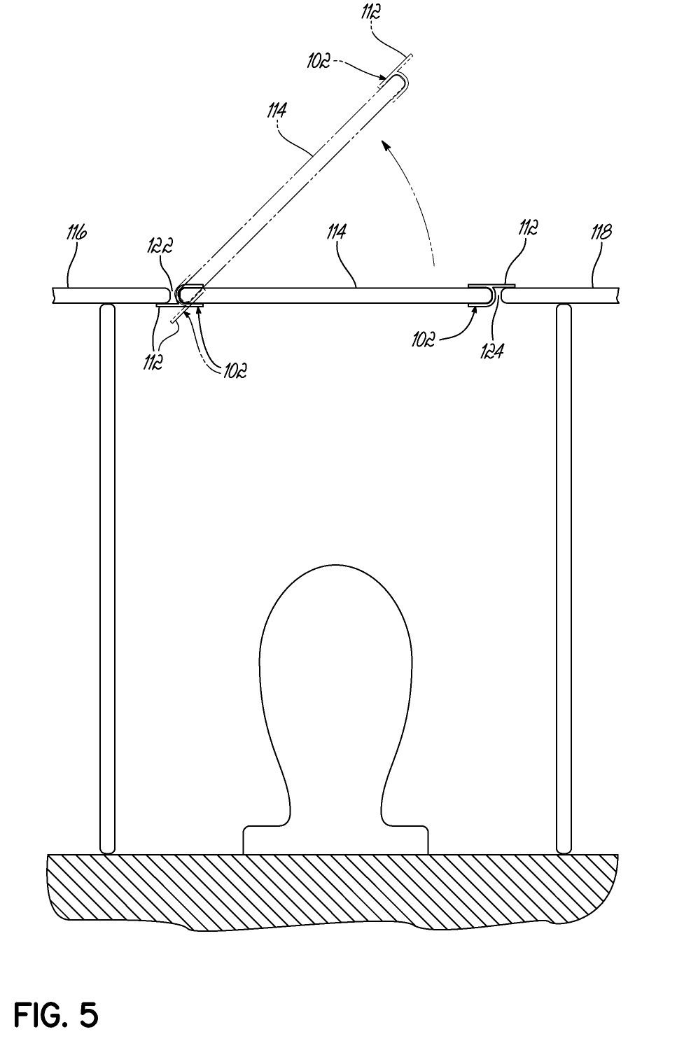

The arm 140 of the device is of a width sufficient to bridge at least a portion of the space 100 between a stall door 114 and a partition panel 116. The width of the ‘arm’ may extend beyond the space 100 such that the outer edge of the arm 140 engages the door 114 or partition panel 116 adjacent the panel to which the attachment edge is secured to prevent the door from swinging beyond the plane of the adjacent partition panel or door as shown in FIG. 5. The device may be installed or integrated on either the door 114 or the partition panel 116. The channel 130 improves the security of the stall by increasing the strength of the stall door by engaging combination of the front side and back surfaces of the door or partition panel.

The device may be installed on either the hinge side and/or the lock side of the stall opening as shown in FIG. 5. The device 100, 102, 104, 106, may be installed on either the stall door 114 or the partition panel 116.

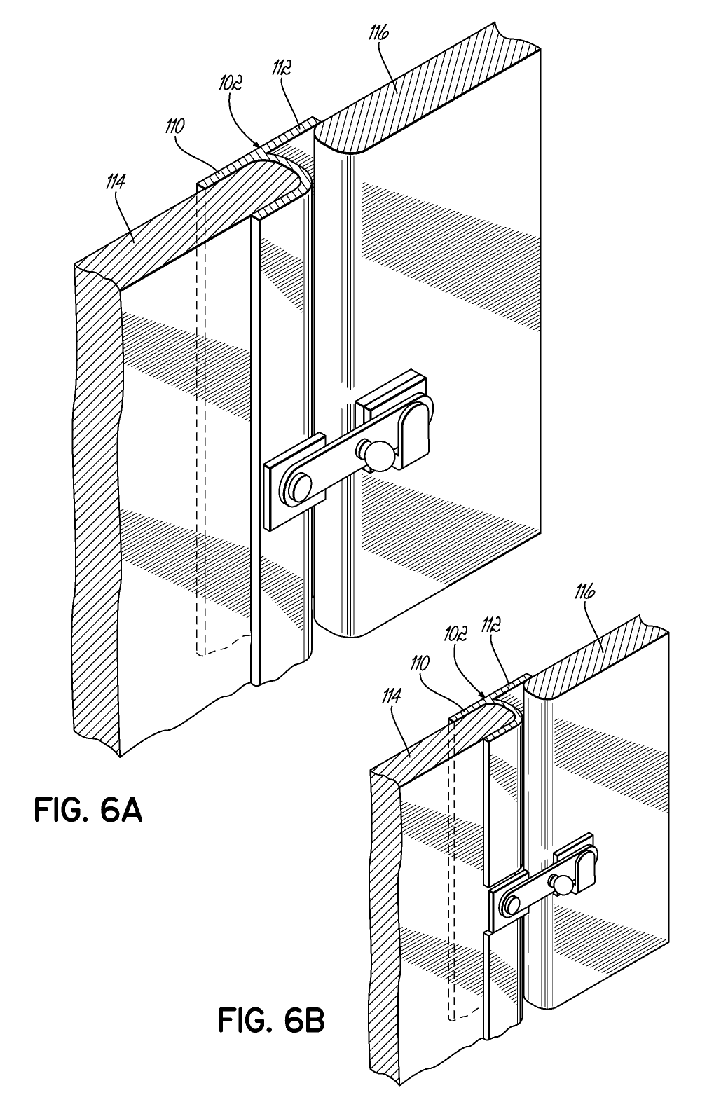

The device can be made out of any metal, polymer, plastic, acrylic, material, stone, glass, and combinations thereof. The device can also have various finishes. The device can include a latch lock integrated into its design on occupant side to provide the operation of a lockable stall (FIG. 6A). The device can also be manufactured so it may be cut in order to fit around existing door locks (FIG. 6B).

The device can include branding and marketing information visible to someone sitting on the toilet. The text may be visible on both ends, top and bottom, in case it is cut and installed around an existing door lock. The text may be routed out or raised so that occupants are not easily able to deface or make-up, graffiti it or destroy the letters.

In one embodiment, the device may be manufactured as a separate piece that is attached to an existing stall door or partition jamb. The device may be permanently or temporarily attached to the door. The device may be formed of a single section or a plurality of section so as to provide space for existing door locks, hinges, and brackets. In one embodiment, the device may also be manufactured as an integral part of the door or partition panel itself, acting as one complete and operational part. More permanent installations of the device maybe attached with mechanical components, such as with screws or bolts, by an adhesive, or by welding. For example, screw holes can be predrilled in the center of the third wall.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and method and illustrative examples shown and described. Accordingly, departures may be made from such details without departing from the general inventive concept.

What is claimed is:

1. A portable privacy device for a stall, the device comprising:
a privacy tape coiled in a housing;
the privacy tape having a length and a width, the length and width being sufficient to extend across the space between a stall door and an adjacent partition panel, wherein the privacy tape is retractable along the length into the housing through an access opening in the housing;
wherein the housing has a channel configured to engage at least one of the door or the partition,
the channel being defined by a first surface for contacting one of an upper end surface or a lower end surface of the at least one of the door or the partition, and
a second surface adjacent the first surface for contacting one of a front surface or a back surface of the at least one of the door or the partition.

2. The device of claim 1 wherein a portion of the privacy tape adjacent the access opening functions as a third surface for contacting the other of the front surface or the back surface of the at least one of the door or the partition.

3. The device of claim 1 wherein the privacy tape has a first end and a second end wherein the first end is coupled to a retraction device and the second end is coupled to a pull tab.

4. The device of claim 3 wherein the retraction device is selected from the group consisting essentially of a coil spring, a crank, and combinations thereof.

5. The device of claim 3 wherein the pull tab includes a channel having a first surface for contacting one of an upper end surface or a lower end surface of the at least one of the door or the partition, and
a second surface adjacent the first surface for contacting one of a front surface or a back surface of the at least one of the door or the partition.

6. The device of claim 5 wherein the channel of the pull tab includes a third surface adjacent the first surface and opposite the second surface, for contacting the other of the front surface or the back surface of the at least one of the door or the partition.

7. The device of claim 5 wherein a portion of the privacy tape adjacent the first surface contacts the other of the front surface or the back surface of the at least one of the door or the partition.

8. The device of claim 5 wherein the first surface of the channel of the tab faces the first surface of the channel of the housing.

9. The device of claim 3 wherein the channel in the housing is configured to receive the pull tab.

10. The device of claim 1 wherein the width of the privacy tape is in a range between about 1 inches and about 5 inches.

11. A method of improving the privacy in a stall by blocking the line of sight through a space between a stall door and an adjacent partition panel utilizing a privacy device having a privacy tape, the method comprising:
selectively and removably securing a first end of the privacy tape to at least one of the door or the partition panel; and
selectively and removably securing a second portion of the privacy tape spaced apart longitudinally from the first end to a second portion of at least one of the door or the partition panel;
wherein the privacy tape extends between the door and the adjacent partition panel.

12. The method of claim 11 wherein the privacy device includes a housing, the method further comprising uncoiling a portion of the privacy tape from the housing.

13. The method of claim 12 wherein the second portion of the privacy tape is selectively and removably secured to the at least one of the door or the partition panel by a channel formed in the housing.

14. The method of claim 11 wherein the first end of the privacy tape is selectively and removably secured to the at least one of the door or the partition panel by a pull tab coupled to the first end of the privacy tape.

15. The method of claim 11 wherein first end of the privacy tape is selectively and removably secured to a respective upper end surface or lower end surface of the at least one of the door or the partition panel.

16. The method of claim 11 wherein the second portion of the privacy tape is selectively and removably secured to a respective upper end surface or lower end surface of the at least one of the door or the partition panel.

17. The method of claim 11 further comprising:
removing the first end of the privacy tape from the at least one of the door or the partition panel; and
removing the second portion of the privacy tape from the second portion of the at least one of the door or the partition panel.

18. The method of claim 11 wherein the privacy device includes a housing, the method further comprising:
removing the first end of the privacy tape from the at least one of the door or the partition panel;
removing the second portion of the privacy tape from the second portion of the at least one of the door or the partition panel; and
retracting the privacy tape into the housing.
